(19) United States
(12) Patent Application Publication
(10) Pub. No.: US 2013/0321303 A1
(43) Pub. Date: Dec. 5, 2013

(54) TOUCH DETECTION

(71) Applicant: Sathish Madanmohan, Lancashire (GB)

(72) Inventor: Sathish Madanmohan, Lancashire (GB)

(73) Assignee: PROMETHEAN LIMITED, Lancashire (GB)

(21) Appl. No.: 13/883,489

(22) PCT Filed: Nov. 4, 2011
(86) PCT No.: PCT/EP11/69467

§ 371 Date: Aug. 20, 2013

(30) Foreign Application Priority Data
Nov. 5, 2010 (GB) 1018767.2

(51) Int. Cl. G06F 3/041

(52) U.S. Cl. CPC G06F 3/0414
USPC 345/173

(57) ABSTRACT

A method of tracking one or more inputs at a touch sensitive surface, comprising: detecting one or more touch inputs in a first scanning frame; for each detected touch input, defining a scanning window around a determined location of the detected touch input; scanning each defined scanning window, in a second scanning frame, to detect one or more touch inputs; associating a touch input detected in each scanning window in the second scanning frame with the touch input in the first scanning frame for which the scanning window was defined.

### BACKGROUND OF THE INVENTION

1. Field of the Invention

The present invention relates to the processing of touch inputs detected at a touch sensitive surface. The invention is particularly concerned with the processing of touch inputs in a multi-touch environment. The invention is particularly, but not exclusively, concerned with the processing of touch inputs at an electronic whiteboard incorporating a touch surface.

2. Description of the Related Art

It is known in the art to provide touch-sensitive surfaces for controlling a computer system. Such surfaces typically include an integrated display, and thus comprise touch sensitive display surfaces.

It is known in the art for touch sensitive display surfaces to be integrated with an electronics device, for example a portable device such as a laptop computer or a handheld device such as a mobile telephone.

It is also known for touch sensitive display surfaces to be used in large scale applications, such as electronic whiteboards for classrooms, in which a large touch sensitive display surface is mounted on a wall or a stand for display to a class of students, and connected to a computer system.

Touch-sensitive display systems have been developed which allow for multiple touches to be detected and processed simultaneously. In such systems, each individual touch must be tracked on the touch sensitive surface. If a touch contact moves on the touch sensitive surface, then this movement must be tracked. In a multi-touch environment, not only must touch contacts be tracked as they move, but also there must be maintained a relationship between the detected touches in successive scanning frames. A scanning frame is a time period within which the surface of the touch sensitive surface is scanned to detect touch contacts. If a touch contact moves position in successive scanning frames, then the system must be able to define a relationship between the touches detected in the current scanning frame and the touches detected in the preceding scanning frame, to track a moving contact point.

Prior art techniques for the detection and tracking of touch inputs in a multi-touch environment are known. Known techniques consume processing resources, as they are process-intensive. Example techniques are disclosed in US2010/097342 and US2010/036580. In these documents, which are typical of the prior art, there are disclosed techniques for tracking touch inputs between scanning frames which include determining positions of contact points in successive frames, and using complex computations to compare the spatial relationships of the positions of the contact points in the current frame with the position of the contact points in the previous frame, to determine the relationship between the contact points in the successive frames.

It is an aim of the invention to provide an improved system and method for tracking touch inputs in a touch-sensitive surface of a multi-touch environment.

### SUMMARY OF THE INVENTION

There is provided a method of tracking one or more inputs at a touch sensitive surface, comprising: detecting one or more touch inputs in a first scanning frame; for each detected touch input, defining a scanning window around a determined location of the detected touch input; scanning each defined scanning window, in a second scanning frame, to detect one or more touch inputs; associating a touch input detected in each scanning window in the second scanning frame with the touch input in the first scanning frame for which the scanning window was defined.

The method may further comprise scanning the surface in the first scanning frame to identify the one or more touch inputs.

The method may further comprise the step of: scanning the surface, in the second scanning frame, to detect one or more new touch inputs. The method may further comprise the steps of: determining if a maximum number of touch inputs has been detected; and scanning the surface, in the second scanning frame, to detect one or more new touch inputs, only if the maximum number has not been reached.

The step of defining the scanning window around a determined location of the detected touch input may comprise: determining the number of contact points detected on the surface; in dependence on the number of contact points detected on the surface being greater than one: determining the distance between a determined location of the detected touch input and a determined location of each further touch input; sizing the scanning window for in dependence on the distance between the determined location of the detected touch input and a determined location of each further touch input being nearest thereto. If the distance between the determined location of the detected touch input and a determined location of each further touch input being nearest thereto is less than a threshold, the window may be defined as a first size; and if the distance between the determined location of the detected touch input and a determined location of each further touch input being nearest thereto is greater than a threshold, the window may be defined as a second size. The second size may be greater than the first size. If the number of contact points detected on the surface is one, the window may be defined as the second size. If the distance between the determined location of the detected touch input and a determined location of the further touch input being nearest thereto is less than a further threshold, then the two touch inputs may be considered as a single touch input.

The invention provides a computer program adapted to perform the method steps. The invention provides a computer program product for storing computer program code which, when run on a computer, performs the method steps.

The invention provides a computer system adapted to track one or more inputs at a touch sensitive surface, comprising: a module for detecting one or more touch inputs in a first scanning frame; a module for defining, for each detected touch input, a scanning window around a determined location of the detected touch input; a module for scanning each defined scanning window, in a second scanning frame, to detect one or more touch inputs; a module for associating a touch input detected in each scanning window in the second scanning frame with the touch input in the first scanning frame for which the scanning window was defined.

The computer system may further comprise a module for scanning the surface in the first scanning frame to identify the one or more touch inputs.

The computer system may further comprise a module for scanning the surface, in the second scanning frame, to detect one or more new touch inputs. The computer system may further comprise: a module for determining if a maximum number of touch inputs has been detected; and a module for scanning the surface, in the second scanning frame, to detect one or more new touch inputs, only if the maximum number has not been reached. Defining the scanning window around a determined location of the detected touch input may comprise: a module for determining the number of contact points detected on the surface; a module for, in dependence on the number of contact points detected on the surface being greater than one: determining the distance between a determined location of the detected touch input and a determined location of each further touch input; sizing the scanning window for in dependence on the distance between the determined location of the detected touch input and a determined location of each further touch input being nearest thereto. The module may be further adapted such that if the distance between the determined location of the detected touch input and a determined location of each further touch input being nearest thereto is less than a threshold, the window is defined as a first size; and if the distance between the determined location of the detected touch input and a determined location of each further touch input being nearest thereto is greater than a threshold, the window is defined as a second size.

The module may be further adapted such that if the number of contact points detected on the surface is one, the window is defined as the second size.

The module may be further adapted such that if the two touch inputs are considered as a single touch input if the distance between the determined location of the detected touch input and a determined location of the further touch input being nearest thereto is less than a further threshold.

There may be provided an integrated display system including a computer as defined.

### BRIEF DESCRIPTION OF THE FIGURES

The invention is now described by way of example with reference to the accompanying figures, in which:

FIG. 1 illustrates the functional modules of a computer system adapted to implement an embodiment of the invention;

FIGS. 2(a) to 2(c) illustrate an example process for tracking touch inputs in accordance with an embodiment of the invention;

FIGS. 3(a) to 3(k) illustrate an example of tracking two touch inputs in accordance with an embodiment of the invention; and

FIG. 4 illustrates an exemplary implementation of an interactive display system adapted in accordance with an embodiment of the invention.

### DESCRIPTION OF THE PREFERRED EMBODIMENTS

The invention is now described by way of exemplary arrangements and embodiments. One skilled in the art will appreciate that the following description sets out example arrangements for describing the invention and its operation, and does not represent restrictions on the scope of the claimed invention.

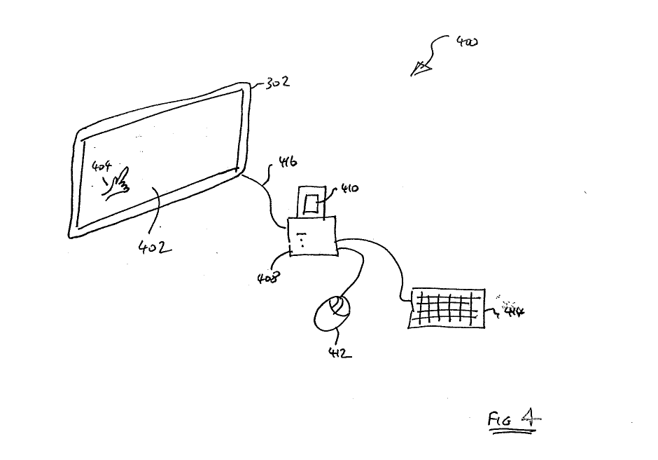

The invention is described herein in the context of an interactive display surface being a touch-sensitive display surface. A particular advantage of a system incorporating a touch-sensitive display surface in which the invention and its embodiments may advantageously be used is described below with reference to FIG. 4. However the invention is not limited to such a specific touch-sensitive display system. For example the invention could be utilized in any electronic device incorporating a touch-sensitive display system.

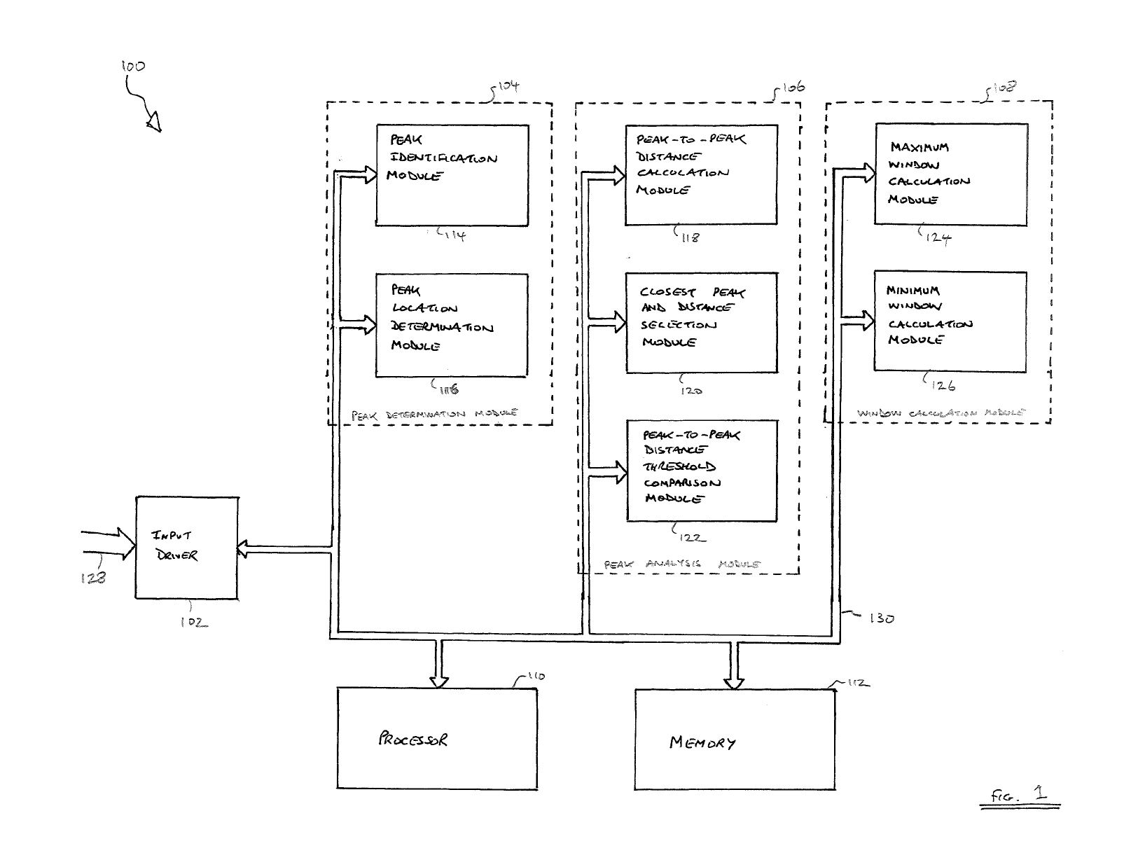

With reference to FIG. 1, there is illustrated the main functional block of a computer system adapted to implement the invention. One skilled in the art will appreciate that additional functional blocks other than those illustrated in FIG. 1 are required in order to implement an appropriate computer system, but the principle functional blocks associated with the operation of the invention are illustrated.

As illustrated in FIG. 1, the computer system 100 includes an input driver 102 for receiving inputs from the touch-sensitive surface on communication lines 128. The computer system 100 additionally includes a processor 110 and a memory 112. The computer system 100 includes a peak determination module 104, a peak analysis module 106, and a window calculation module 108. All elements of the communication system are connected via a communication bus 130. The peak determination module 104 includes a peak identification module 114 and a peak location determination module 116. The peak analysis module includes a peak-to-peak distance calculation module 118, a closest peak and distance selection module 120, and a peak-to-peak distance threshold comparison module 122. The window calculation module 108 includes a maximum window calculation module 124 and a minimum window calculation module 126.

Each of the modules 104, 106 and 108, and their sub-modules as identified, is adapted to perform a functionality in a computer system to support operation of features of the invention and the preferred arrangements as set out herein. Data used in the processing of these functions may be stored in the memory 112, and the processing of the functions may be carried out under the control of the processor 110.

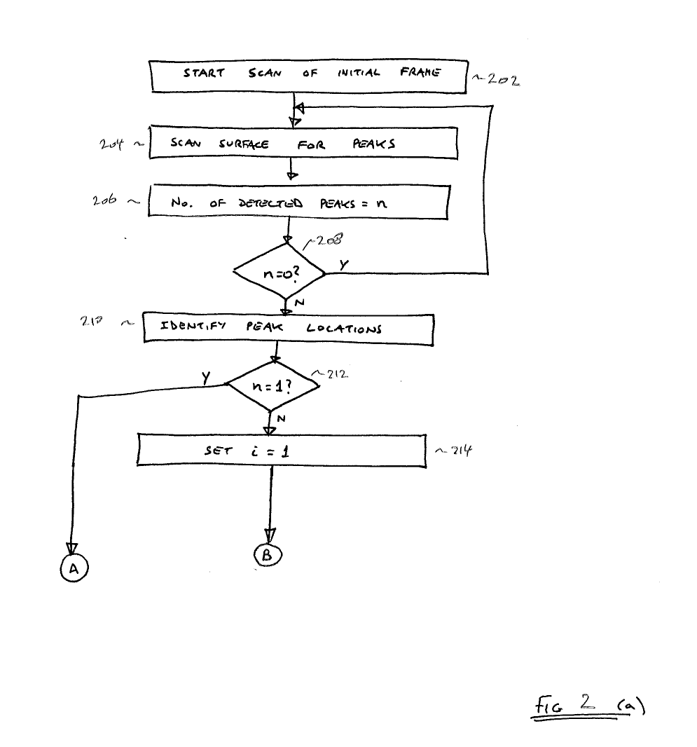

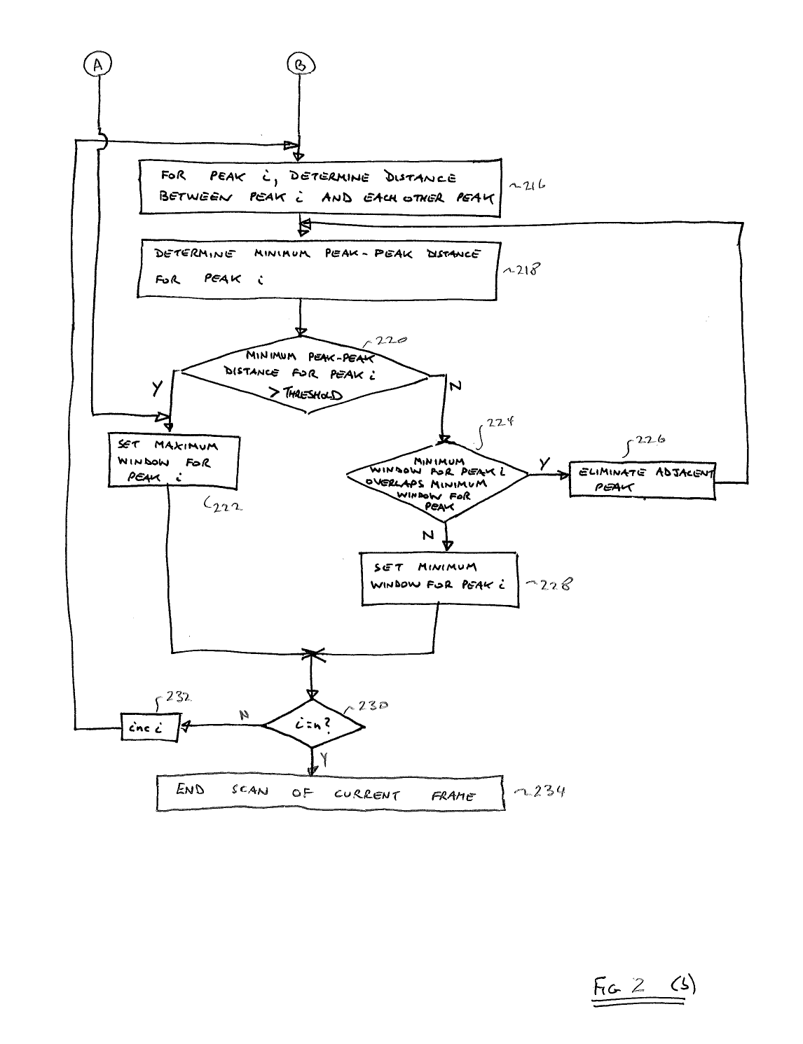

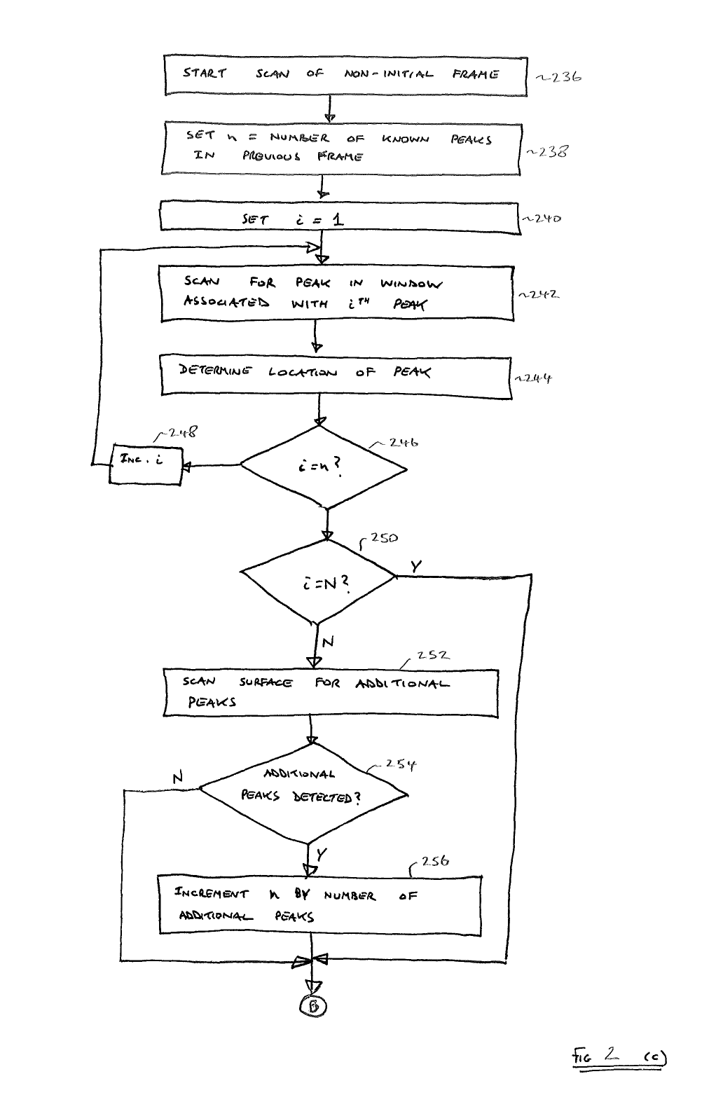

With reference to the flow diagrams of FIGS. 2a to 2c, in conjunction with the computer system of FIG. 1, the principles of operation of the invention in accordance with a particular embodiment are now further described.

The invention and its embodiments particularly relate to an environment in which multiple touch inputs at a touch-sensitive surface may be detected, the multiple touch inputs being provided by one or more users. In a typical touch system, the system will be adapted to support the detection and tracking of a maximum number of touch inputs simultaneously, which maximum number may be denoted as N. In the following examples reference may be made to specific embodiments in which a particular number is stated as the maximum possible number, but one skilled in the art will appreciate that the maximum number of touch inputs which may be detected and tracked simultaneously will be dependent upon the design and implementation of the touch system, and the invention and its principles are not limited to a specific number of maximum touch inputs.

Referring to FIG. 2a, as denoted by step 202 in an initial operation a scan is carried out on an initial frame. The scan refers to a scan of the touch-sensitive surface to detect touch inputs. Technology and techniques for scanning a touch surface in order to detect touch contacts are well-known in the art, and the invention is not limited to any specific technique for such. In general, the detection of a touch input on the surface is detected during a scan operation by identification of a peak in signal outputs from an array formed on the touch-sensitive surface. In an example, the touch-sensitive surface may be scanned every 12.4 ms to obtain a frame of data. Such a scanning operation may be controlled under the control of the processor 110, and the data for the frame obtained in the scanning process may be stored in the memory 112. Once the transfer of data for the frame is complete, the processor 110 may generate an interrupt to initiate the processing of the data which has been obtained. In a background routine, another set of data corresponding to the succeeding frame, i.e. a succeeding scan of the touch-sensitive surface to detect contacts, is transferred into another memory location of the memory 112. The scanning of the touch-sensitive surface to obtain data, and the processing of that data to obtain information to identify peaks and thereby identify contact points, is outside the scope of the invention, and such techniques are well-known to one skilled in the art.

Thus as further illustrated in FIG. 2a, following the start of the scanning of the initial frame in step 202, in step 204 a scan is made of the touch-sensitive surface to identify peaks, which operation is carried out by the peak identification module 114.

In a step 206 it is determined how many peaks have been detected, and the value n is set to the number of detected peaks.

In step 208 it is determined whether the value n is equal to 0. If the value n is equal to 0 then no peaks have been detected, and the process returns to step 204. If the value n is not equal to 0, then at least one peak has been detected, and the process moves on to step 210.

In step 210 the locations of the identified peaks are determined, which processing is carried out by the peak location determination module 116.

Thereafter in a step 212 a determination is made as to whether the value n is equal to 1. If the value n is equal to 1, and therefore only one peak has been detected, then the process moves on to a subsequent step 222 as will be described further hereinafter. If the value n is not equal to 1, then it is greater than 1, and the process moves on to a step 214. In the step 214, a value i is set equal to 1 and an iterative process is then performed for each detected peak. The iterative process for processing an initial frame is illustrated with respect to FIG. 2b. As illustrated in FIG. 2b, following the step 214 the process moves on to step 216. In step 216, for the peak i a distance between that peak and each other detected peak on the touch-sensitive surface is determined. This operation is carried out by the peak-to-peak distance calculation module 118 of the computer system 100. Thus the number of distance determinations which are made for the peak i is n−1.

In a subsequent step 218, it is then determined the minimum peak-to-peak distance for the peak i, this operation being performed in the closest peak and distance selection module 120 of the computer system 100. Thus the smallest of the n−1 distances is determined in step 216 as identified in step 218.

In a step 220 the determined minimum peak-to-peak distance for peak i is compared to a threshold value. This operation is carried out in the peak-to-peak distance threshold comparison module 122 of the computer system 100.

The threshold is a distance value, denoted by D, with which the minimum peak-to-peak distance for peak i is compared. The distance threshold D may be set in dependence upon the requirements of an implementation. The significance of the threshold D will be apparent from the following description. However, in accordance with the principles of the invention, in frames subsequent to the initial frame, the scanning of the surface is based on a scan of a window representing a sub-area of the surface. The window is positioned at a location where a contact point is detected in a current frame. The size of the window is determined by the comparison of the minimum peak-to-peak distance for peak i to the threshold. If the minimum peak-to-peak distance for the peak i is greater than the threshold, then the window is set at a large size (as will be discussed in further detail hereinbelow); if the minimum peak-to-peak distance for peak i is less than the threshold then the window is set at a small size (as will be discussed in further detail hereinbelow).

In determining in step 218 the minimum peak-to-peak distance for peak i, the distance will represent the distance between the peak i and another peak which is the closest peak-to-peak i amongst one or more further peaks. This peak may be considered to be the neighbouring peak of the peak i.

The peak-to-peak distance threshold comparison module 122 of the computer system 100 performs the comparison of step 220, in dependence on a predetermined threshold value D.

If in step 220 it is determined that the minimum peak-to-peak distance for peak i is greater than the threshold, then the process moves on to step 222. In step 222 the maximum window size for peak i is set. As a result, in the subsequent scanning frame, the size of the window which will be scanned to track the touch contact generating the peak i will be set at a maximum size.

As mentioned hereinabove, if in step 212 it is determined that the value n is equal to 1, and therefore only one peak is present, then the process moves on directly to step 222. In such a scenario the scanning window for the subsequent frame for peak i is set to be the maximum size automatically, as there is no additional peak on the surface to make a distance comparison with.

In the maximum window calculation module 124 of the computer system 100 the maximum window step 222 is performed. The maximum window calculation module 124 calculates the coordinates of the window in dependence upon the detected position of the peak i, and the size of the window associated with a maximum window.

If in step 220 it is determined that the minimum peak-to-peak distance for peak i is less than the threshold, then in step 224 an additional processing step is carried out in the peak-to-peak distance threshold comparison module 122. In the step 224, a determination is made as to whether the minimum window for peak i overlaps with the minimum window for the neighbouring peak. If this overlap condition is detected, then it is determined that the peak i and a neighbouring peak are too close together to be distinguished, and are therefore considered as a single peak.

If this condition is met, then in a step 226 the neighbouring or adjacent peak is eliminated. This process assumes that the peaks are processed in the order in which they are detected, and therefore the peak i currently being processed was detected prior to the neighbouring peak being detected. As such the peak i is taken to be the “senior” contact point, and the peak associated with the neighbouring contact point is eliminated rather than the peak associated with the current processing iteration.

Following step 226 and the elimination of the adjacent peak, the process returns to step 218 for further processing. This process must return to step 218 in order to determine a new minimum peak-to-peak distance for the peak i, given the elimination of the previously determining neighbouring peak. This may result in a different determination in the processing step 220.

If in step 224 it is determined that the minimum window for peak i does not overlap the minimum window for the neighbouring peak, then in step 228 a minimum window size is set for peak i, which step is implemented in the minimum window calculation module 126 of the computer system 100. The minimum window calculation module 126 determines the window for the subsequent processing step for the contact associated with peak i, in dependence upon the determined location of the peak and the predetermined size of the small window.

Following either of steps 222 or 228 the process moves on to step 230, in which it is determined whether i is equal to n. If i is not equal to n then there are further peaks to be processed, and in step 232 the value i is incremented and then the process proceeds to the next iteration for the next peak in step 216, and the subsequent steps are repeated.

If it is determined in step 230 that the value i is equal to the value n, then in step 234 it is determined that the scan of the current frame has terminated.

With reference to FIG. 2c, there is illustrated the process steps in processing a subsequent frame to the initial frame. The scan of the subsequent frame, which can be any frame which is not the initial frame, is initiated in a step 236.

In a step 238 the value n is set to be the number of known peaks detected in a previous frame. In a step 240 the value i is set to be equal to 1 at the start of an iterative process.

In step 242 for the peak i detected in the previous frame, a scan is carried out in the window calculated for that peak in the previous frame. Thus a scan of the full touch-sensitive surface is not carried out, and only a scan within the determined window is carried out.

In step 244 the determination of the location of the peak in the current frame is made. The steps 242 and 244 are performed by the peak determination module 104 of the computer system 100, consistent with the operation of the computer system in the method flow of FIG. 2b.

In a step 246 it is determined whether the value i is equal to the value n. If the two values are not equal, then there are additional peaks detected in a previous frame to be processed in this frame, and the process moves on to the step 248 and the value i is incremented by 1. The steps 242 and 244 are then repeated for all n detected contact points or peaks in the previous frame in an iterative process.

If in the step 246 it is determined that i is equal to n, then the process moves on to step 250.

When i is determined to be equal to n in step 246, then the processing of the contact points associated with the peaks detected in the previous frame have all been completed. As will be understood, this processing is completed based on the scanning of a window around the location of the peak in the previous frame, rather than a full scan of the contact surface. This significantly reduces the processing time required to process the location of the peak detected in the previous frame in the current frame. Moreover, the processing required in order to track a peak detected in a previous frame, and associate the peak detected in the current frame with the peak detected in the previous frame is significantly simplified. The establishment of a window in identifying the peak in the previous frame and only scanning in that window in the subsequent frame, means that any peak found in that window in the subsequent frame is automatically associated with the corresponding peak in the previous frame. Thus complex processing is not required in order to make a determination as to which peak detected in the current frame is associated with which peak detected in a previous frame.

In a step 250 it is determined whether the value i is equal to the value of N. As noted hereinabove, the value N represents the maximum number of contacts which can be simultaneously tracked in the system. If the value i is not equal to N, then the system can potentially track additional contact points. Therefore a determination is made as to whether any new contact points have been made on the surface since the previous frame.

Thus if it is determined that i is not equal to N, in a step 252 a scan is made of the whole surface for additional peaks. In step 254 it is determined whether additional peaks are detected. If additional peaks are detected then the value n is increased by the number of additional peaks in a step 256. Following step 256, the process moves on to step 216 and the process of FIG. 2b is implemented. If in step 254 it is determined that no additional peaks have been detected, then the process similarly moves on to step 216 and the process of FIG. 2b is repeated. If it is determined in step 250 that the value is equal to the value N, then the process moves on to step 216 and the process of FIG. 2b is repeated.

Thus for each subsequent frame the process of FIG. 2b is repeated once the current location of the various peaks has been determined, in order to re-calculate the scanning window for each detected peak, or calculate an initial scanning window for any newly detected peaks, in accordance with the description of FIG. 2b set out hereinabove.

Thus there is illustrated an advantageous technique for tracking contact points in a multi-touch-sensitive surface. In an initial timeframe, the peaks are identified and the peak values associated therewith are registered along with their positions. In a subsequent timeframe, the tracking of the existing peak/touches is performed. The process prepares the tracking window for each touch point in the subsequent timeframes, based on the distance between the existing peaks.

From the history of the past frames the distance between the non-0 peak values with respect to each touch point is calculated based on known methods, for example by a Pythagorean method. For example when there are four non-0 touch points, corresponding to four detected peaks, registered in the previous timeframe then the distance between each peak and the other three peaks is calculated. The minimum distance between each peak and the other three peaks is then compared against the distance threshold. If the minimum distance for each peak is greater than the distance threshold then the search window is set at a large or maximum window size. If the minimum distance between each peak and the other peaks is less than the distance threshold then the search window is set at the minimum window size. This avoids the confusion of identifying the touches and tracking the right peak. The same technique is adopted for all of the non-0 peaks representing contact points, in the preferred arrangement each non-0 peak or contact point being processed in the order in which it is detected. The search or scanning window for each peak will be determined independently in dependence upon the minimum distance between it and the nearest other peak, such that for each contact point an independent decision is reached to determine the size of the scanning or search window.

If there are only two non-0 peaks detected, i.e. only two touch contact points on the surface, the distance is considered only between those two non-0 peaks. Where there is only one peak detected, and therefore only one touch contact point detected, the search window is preferably always set to a maximum. This increases the tracking speed and also improves the processing efficiency.

Once the tracking decision is made, the touch points in the current frame are tracked in the subsequent frame using the search window size assigned for each peak. This improves the detection of peaks in the current frame and minimises the tracking loss when the movement of the contact point on the surface is fast. Once all the non-0 touch points are identified in the current frame, the new positions are updated. Also the history is updated with the new values which are then used as a reference for the next consecutive frame. Thus once the initial frame is processed, a tracking window is used in each subsequent frame to minimise the scanning and processing required to track a touch contact point, and the location of the scanning window is updated for each scanning frame in dependence upon the determined location of the touch contact position associated with that scanning window in the previous frame.

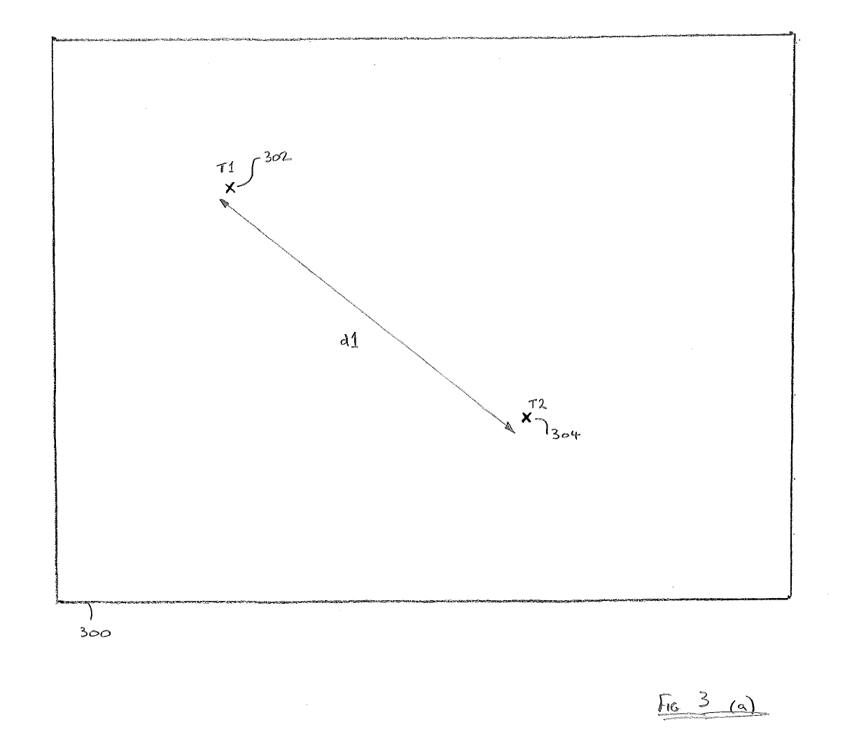

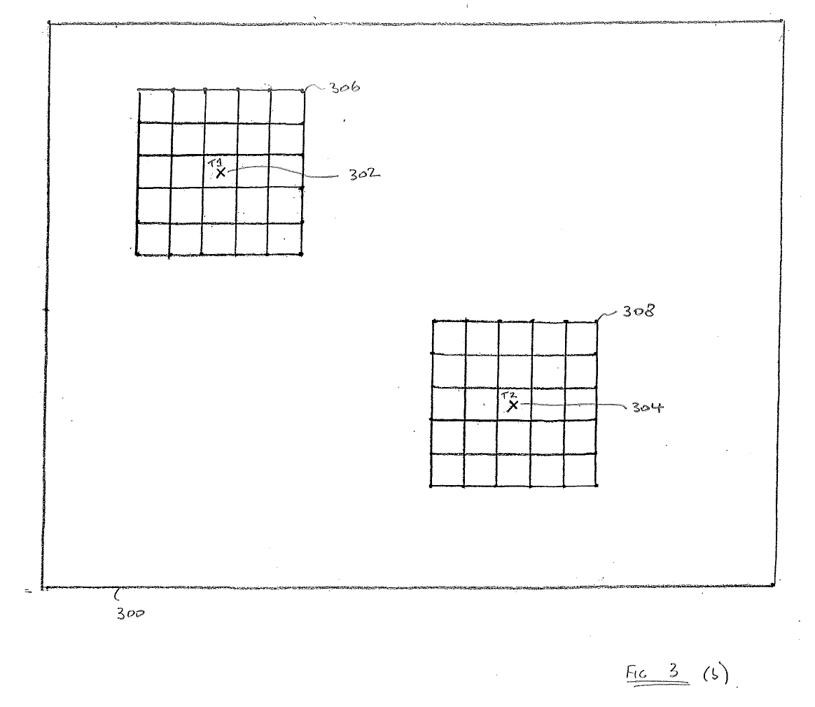

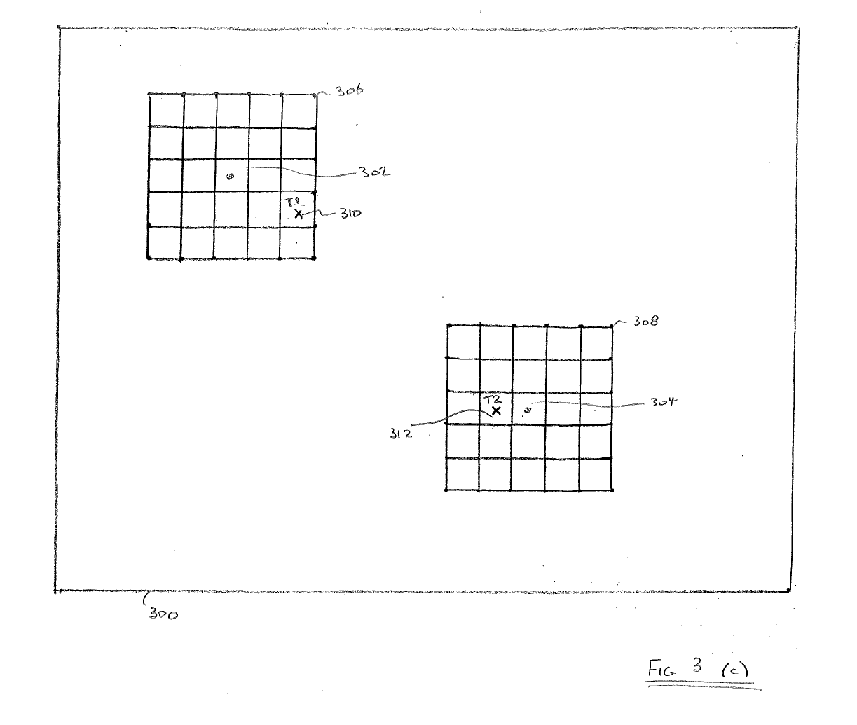

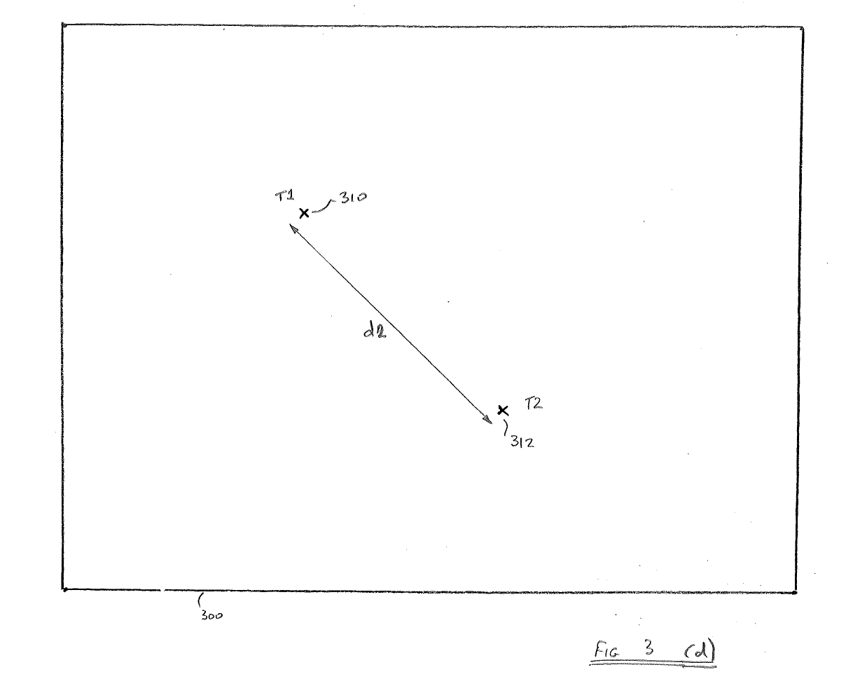

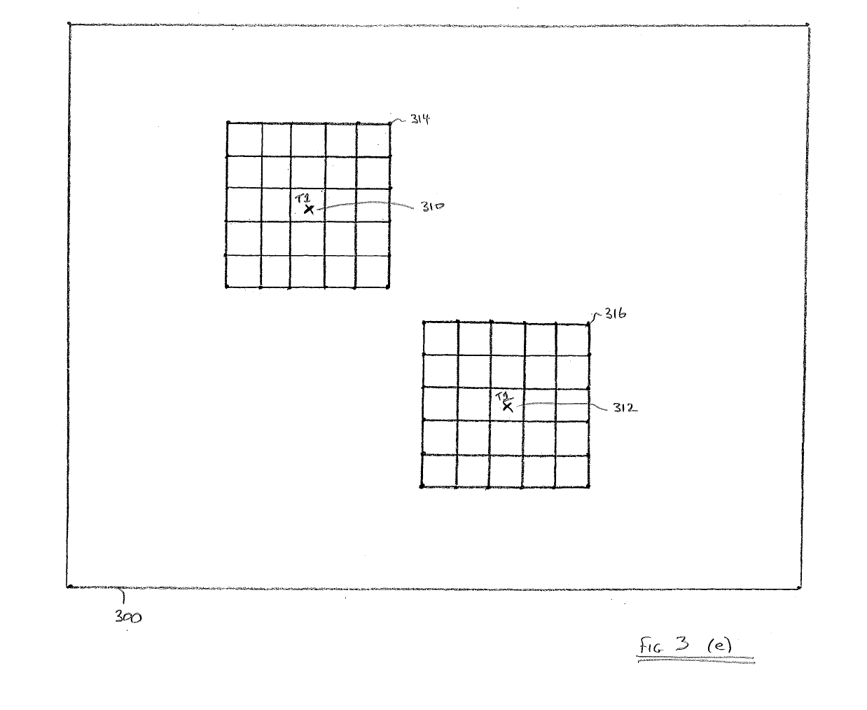

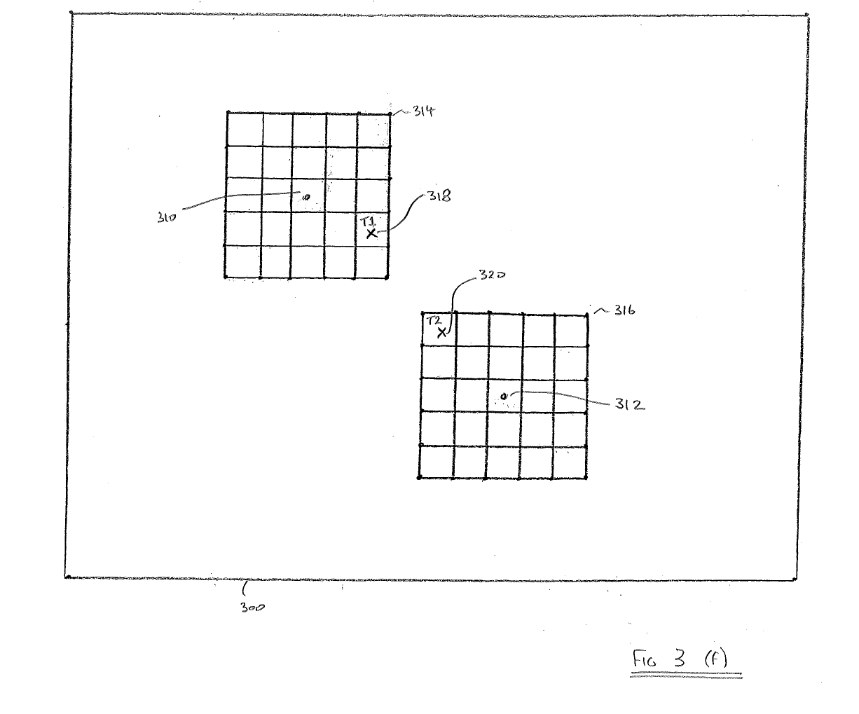

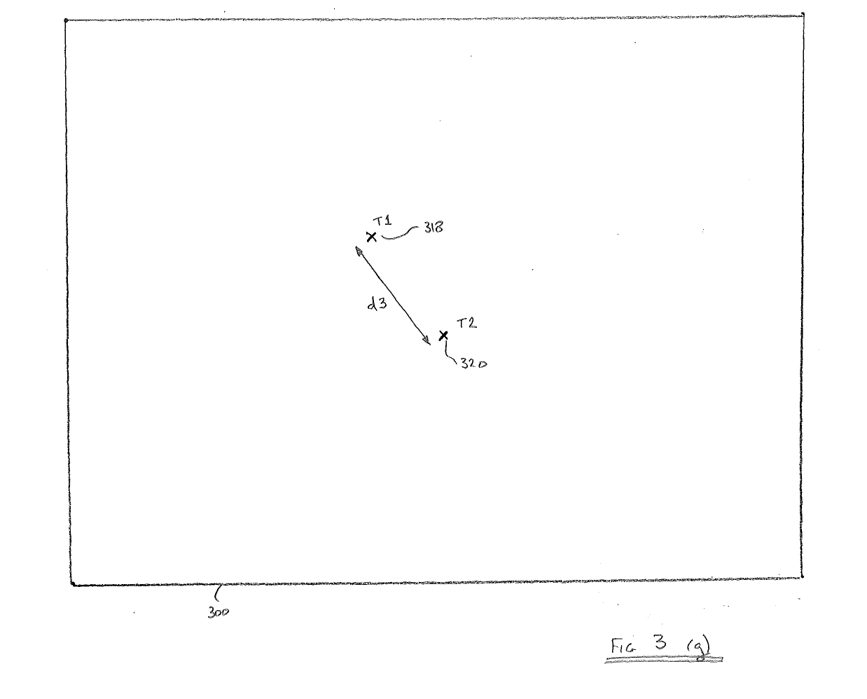

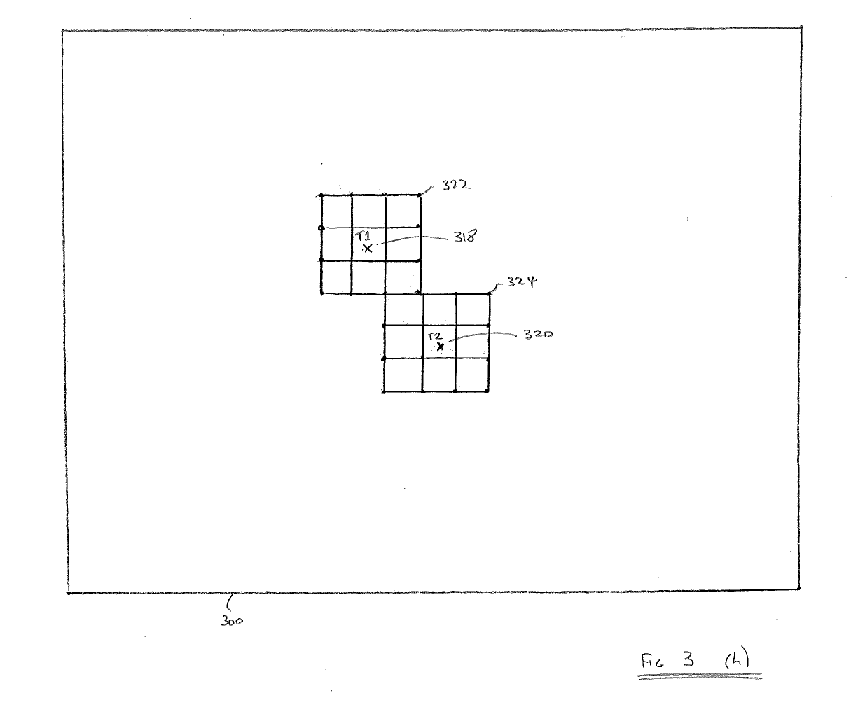

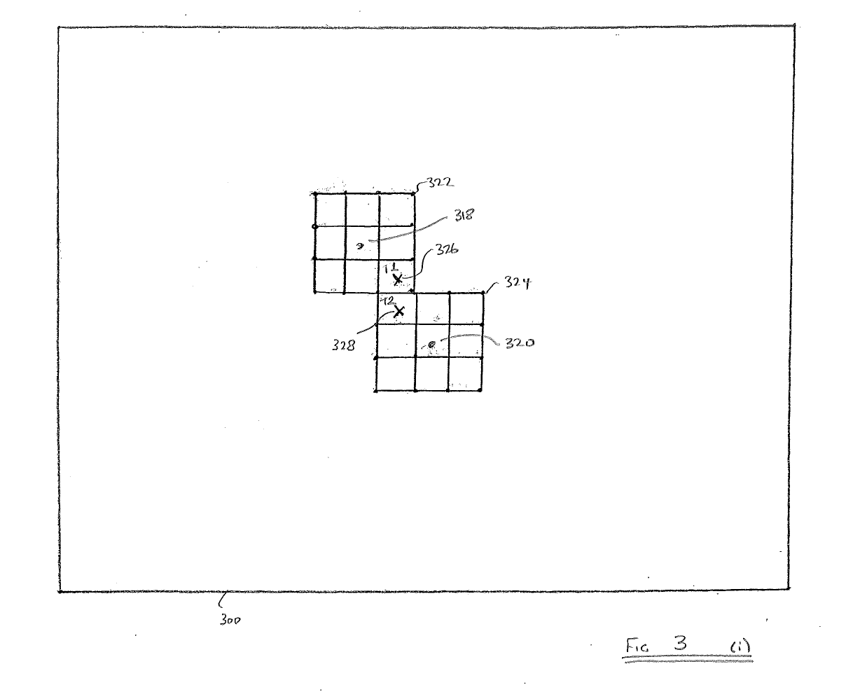

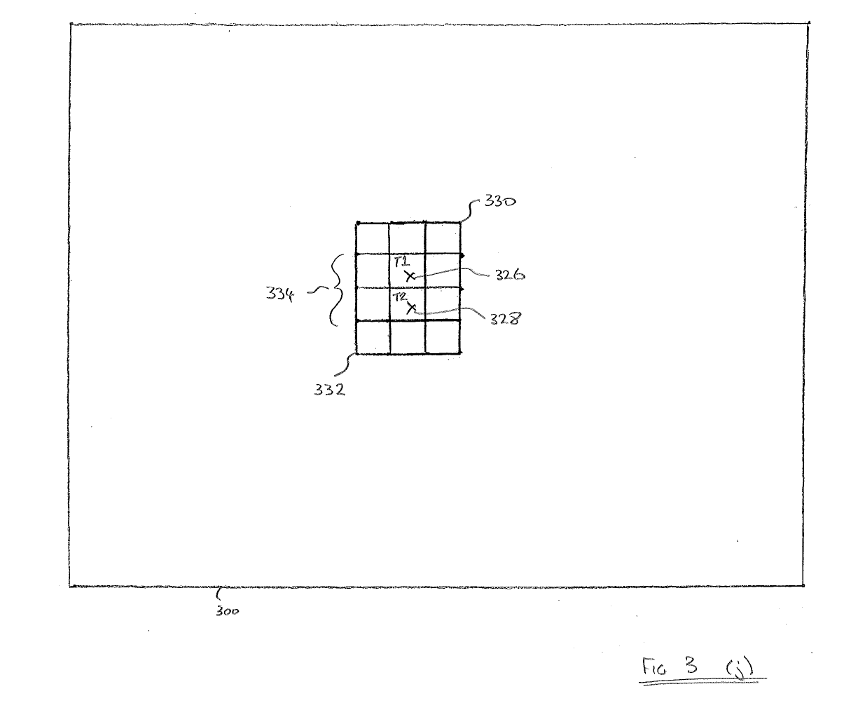

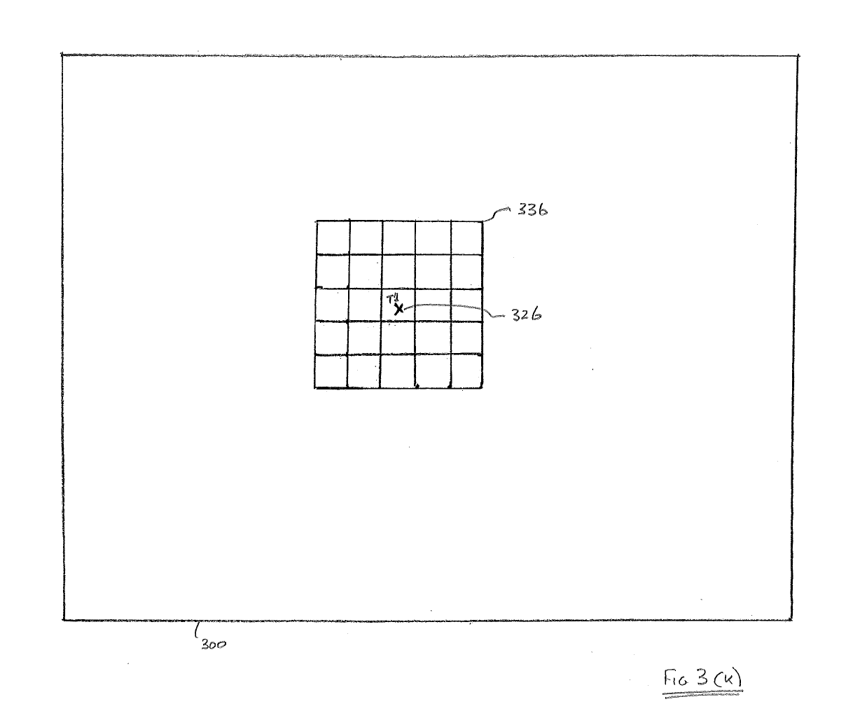

The invention will now be further described by way of reference to a particular example relating to the tracking of two contact points on a touch-sensitive surface, as illustrated with respect to FIGS. 3a to 3k.

With reference to FIG. 3a, there is generally illustrated a touch-sensitive surface 300. A first contact point T1 is present at a location denoted by a cross with reference numeral 302. A second contact point T2 is located at a position denoted by a cross with reference numeral 304. In accordance with the techniques described hereinabove, the contact points at locations 302 and 304 are detected initially in an initial scan of the touch-sensitive surface.

It should be noted in FIGS. 3a to 3k that the touch-sensitive surface and the windows for scanning in accordance with the techniques of the invention are not drawn to scale, but are drawn to best illustrate an exemplary arrangement in accordance with the invention.

In accordance with the techniques described hereinabove, in an initial scanning process once the contact points at positions 302 and 304 are determined, a calculation is made to determine the distance therebetween, which as illustrated in FIG. 3 is denoted as a distance d1. As this simplified example presents an arrangement in which only two contact points are detected, there is no requirement to compare the distances between any given contact point and multiple other contact points, since the single distance provided represents the only distance.

In accordance with the techniques described hereinabove, the distance d1 is then compared with the threshold distance D. In the arrangement of FIG. 3a, it is assumed that the distance d1 is greater than the threshold distance D.

Turning now to FIG. 3b, in accordance with the determination that the distance d1 is greater than the distance D, a scan window, or search window, for each of the contact points 302 and 304 is generated in dependence on the maximum window size. Thus as illustrated in FIG. 3b, a scan window 306 is defined around the contact point 302, and a scan window 308 is defined around the contact point 304. It will be understood to one skilled in the art that the scanned windows are not displayed on the touch-sensitive surface, but merely denote an area of the touch-sensitive surface within which scanning for a contact point will be performed, or more particularly will be restricted to rather than performed over the whole touch-sensitive surface.

Thus, with reference to FIG. 3b, there is illustrated a 5×5 window 306, which has its central point, i.e. its central detection point, located at the position 302. Similarly there is denoted a 5×5 window 308 which has a central point about the contact point 304. The scanning windows 306 and 308 denote the locations which will be scanned in order to track the movement of the contact points T1 and T2. The windows are denoted as being sized 5×5, as providing a detection grid space of 5×5 grid spaces around the contact point locations 302 and 304.

Thus in a subsequent scanning frame to the frame of FIG. 3a where the contact points are detected, scanning is performed only in the locations defined by the windows 306 and 308 centred on the contact points 302 and 304.

As illustrated in FIG. 3c, in a subsequent scanning frame to the frame of FIG. 3a, the first contact point of touch T1 has moved from the location 302 to the location 301, which is detected within the window 306. The second contact point of touch T2 has moved from the location 304 to the location 312, which is in the second scanning window 308. Thus the touch input detected at the location 310 is associated with the contact point T1, by virtue of a detection within the window 306, and the touch contact input at a location 312 is associated with the touch T2 in view of its detection in the window 308.

Following the detection of the contact points in the subsequent frame of FIG. 3c, as denoted in FIG. 3d a further calculation is carried out to detect the distance between the locations 310 and 312. As illustrated in FIG. 3d, this distance is determined to be a distance d2. This is compared to the distance D, and is determined to be greater than the distance D. Thus as illustrated in FIG. 3e, there is determined two new scanning windows for the touch contacts T1 and T2. The scanning windows are determined to be of a maximum size. Thus there is illustrated a scanning window 314 for the first contact point T1 located and centred about the position 310, and a scanning window 316 for the contact point T2 located and centred about the location 312. The scanning windows of FIG. 3e illustrate the location of the scanning windows for the subsequent frame, based on the detection of the contact points being in the locations 310 and 312 in the current frame.

As illustrated in FIG. 3f, following a scanning in a subsequent frame, a contact point at location 318 is detected in the window 314, which is determined to be the first contact T1. A contact is detected at location 320 in the second window 316, which is determined to be the second contact T2. As with FIG. 3c, the contact points detected in the windows 314 and 316 are determined to be associated with the touch contacts for which the window was defined. As can be seen the touch contact T1 has moved from the location 310 to the location 318, and the touch contact T2 has moved from the location 312 to the location 320.

Again, a distance is determined between the new locations 318 and 320, which as illustrated in FIG. 3g is determined to be a distance d3. This distance is compared with the threshold distance D, and in this comparison the distance d3 is determined to be smaller than the distance D. As such, the distance d3 is smaller than the threshold value D.

As therefore illustrated in FIG. 3h, a small window is defined for each of the scanning windows for the subsequent frame. Thus a 3×3 scanning window 322 is defined around the contact location 318 for the first contact point T1, and a second 3×3 scanning window 324 is defined about the location 320 for the second contact point T2. The scanning windows 322 and 324 represent the locations within which scanning will take place in the subsequent frame to track the positions of the contact points T1 and T2.

As illustrated in FIG. 3i, following scanning in the subsequent frame is determined that there is a contact point in location 326 in the window 322, which represents the first contact point T1. There is a further determined contact point at location 328 in the window 324, which represents the current contact point of the second touch input T2. Thus the first touch input T1 has moved from the location 318 to the location 326, and the second touch input T2 has moved from the location 320 to the location 328.

In accordance with the above processes, although not illustrated in FIG. 3 again the distance between the positions 326 and 328 will be measured, and as this distance is now smaller than the distance d3 the result will be that the distance between the two peaks is again smaller than the threshold distance D. This determines that a small size scanning window should be set.

However, with reference to FIG. 3j, it can be seen that in the event that a small scanning window denoted by reference 330 is defined for the location 326, and a small scanning window 332 is defined for the location 328, both scanning windows being 3×3 scanning windows, the respective scanning windows overlap in an area denoted by reference numeral 334. Thus the overlap condition occurs.

As a result, and in accordance with the above described preferred arrangement, the second of the contact points T2 at location 328 is eliminated, and the first contact point T1 at location 326 is determined to be the only contact point. As no other contact points exist on the surface, the scanning window for the contact T1 at location 326 is determined to be a large scanning window, and as illustrated in FIG. 3k a large scanning window 336 is defined around the location point 326 for the first touch contact T1 for use in scanning in the subsequent frame.

FIGS. 3a to 3k describe an exemplary implementation referring to two touch contact points. As mentioned hereinabove, multiple contact points may be present on the surface and the invention may be extended to any implementation with any number of contact points, and the example of two contact points in FIGS. 3a to 3k is simply an illustrative arrangement.

A particularly advantageous implementation of a computer system in which the invention and its embodiments may be utilised is illustrated with respect to FIG. 4.

With respect to FIG. 4 there is illustrated an interactive display system, such as may be provided in a classroom environment for educational purposes. A touch screen system denoted by reference numeral 303 comprises a large vertical touch-sensitive display surface 402, which may be interactive with via a user's hand as denoted by reference numeral 404. A computer system 408 is connected either wirelessly or via a wired connection 416 to the touch screen system 302. The touch screen system 302 is used to display information associated with applications running on the computer system 408, and the computer system 408 is adapted to process inputs received from the touch-sensitive display surface 402 of the touch screen system 302.

The computer 408 is provided with additional input devices in FIG. 4, such as a mouse 412 and a keyboard 414. In addition the computer 408 is shown as having a display 410 associated therewith, which may display the same information as is displayed on the touch-sensitive display surface 402.

For the exemplary implementation of FIG. 4, the touch-sensitive display surface comprising the electronic whiteboard typically has a 64×128 grid. In a preferred implementation, the maximum window size is set as a 7×7 grid, and the minimum window size is set as a 2×2 grid. The 2×2 grid limits tracking of touch contact points when a touch contact movement is fast. Therefore the 7×7 grid size is preferable in order to allow tracking of fast movement and improve overall operation of the tracking on a touch-sensitive display surface. The ability to track moving touch points effects system performance, and the amount of processing required to track contact points between successive frames may result, in the prior art, in limitations in tracking fast contact points, which may result in contact points appearing to “jump” or jitter on the display. Using the technique of the present invention, tracking points moving at faster speeds than the prior art can be tracked without any “jump” or jitter in the displayed movement of the contact points.

Fetching the data from the external memory on every frame, in the prior art, increases processing time. This is because in the prior art the full scanning data for the entire touch-sensitive surface must be fetched and processed for each frame, and then the relationship between detected contact points with the detected contact points in the previous frame calculated. The implementation of the technique in accordance with the invention minimises the search for an existing touch point. This technique is efficient in terms of memory usage and improved performance.

In a preferred embodiment, if only one peak is registered in the previous frame, then the search window is set to a maximum of 7×7 grid size and the touch point (or peak) is searched for within this window only. When there is more than one touch registered in a previous frame, then the distance between the non-0 peak values with respect to each touch point is calculated. When the distance between each non-0 peak is greater than the threshold distance then the search window is set to the 7×7 grid size, thus providing good tracking speed and accuracy, which improves the tracking speed and accuracy of the prior art. If the distance between any two non-0 peaks (or touches) is less than the threshold distance, then the search window is preferably set to a 2×2 grid for these two non-0 peaks, and the rest of the peaks have a search window of 7×7. Although for the touch contact points having a search grid of 2×2 tracking speed and accuracy is reduced compared to a window of 7×7, this provides comparable performance with prior art techniques.

Thus the invention provides an adaptable search window for identifying existing touches in the current frame, and for tracking those touches in subsequent frames, whilst improving tracking speed and accuracy, and minimising processing time.

The method of the invention as described herein may be implemented in software. Computer program code associated with such software may be stored on a computer storage medium, such as a hard disk of a computer system, a disk or memory storage device which may interact with the computer system, or may be accessible via a network connection such as an internet connection.

When run on a computer system, the computer program code may cause the computer system to operate in accordance with the methods described herein with reference to the invention and its embodiments. A computer system for running software associated with such computer program code may have basic functionalities simply to support running of a program based on such computer program code, or may have additional functionality.

A computer system may also be adapted in order to provide apparatus, by way of functional modules, for implementing the invention and embodiments thereof. Functional modules of the computer system may be adapted to cause the computer system to operate in a way beyond the normal operation of the computer system, to cause the computer system to operate in accordance with the principles of the invention and its embodiments.

The invention has been described herein by way of reference to specific examples and embodiments to aid the explanation and understanding of the invention. The invention is not limited to the specifics of any embodiment given herein, and the scope of protection afforded by the invention is defined by the appended claims. The invention is not limited to any specific combination of features of an embodiment as described herein, and different embodiments described are not mutually exclusive. Individual elements of any described embodiment may be combined and separated.

1. A method of tracking one or more inputs at a touch sensitive surface, comprising:
detecting one or more touch inputs in a first scanning frame;
for each detected touch input, defining a scanning window around a determined location of the detected touch input;
scanning each defined scanning window, in a second scanning frame, to detect one or more touch inputs;
associating a touch input detected in each scanning window in the second scanning frame with the touch input in the first scanning frame for which the scanning window was defined.

2. The method of claim 1 further comprising:
scanning the surface in the first scanning frame to identify the one or more touch inputs.

3. The method of claim 1, further comprising the step of:
scanning the surface, in the second scanning frame, to detect one or more new touch inputs.

4. The method according to claim 3, further comprising the step of:
determining if a maximum number of touch inputs has been detected; and
scanning the surface, in the second scanning frame, to detect one or more new touch inputs, only if the maximum number has not been reached.

5. The method according to claim 1 wherein the step of defining the scanning window around a determined location of the detected touch input comprises:
determining the number of contact points detected on the surface;
in dependence on the number of contact points detected on the surface being greater than one:
determining the distance between a determined location of the detected touch input and a determined location of each further touch input;
sizing the scanning window for in dependence on the distance between the determined location of the detected touch input and a determined location of each further touch input being nearest thereto.

6. The method according to claim 5, wherein if the distance between the determined location of the detected touch input and a determined location of each further touch input being nearest thereto is less than a threshold, the window is defined as a first size; and if the distance between the determined location of the detected touch input and a determined location of each further touch input being nearest thereto is greater than a threshold, the window is defined as a second size.

7. The method of claim 6 wherein the second size is greater than the first size.

8. The method of claim 6 wherein if the number of contact points detected on the surface is one, the window is defined as the second size.

9. The method of claim 5 wherein if the distance between the determined location of the detected touch input and a determined location of the further touch input being nearest thereto is less than a further threshold, then the two touch inputs are considered as a single touch input.

10. A computer program adapted to perform, when run on a computer, the method according to claim 1.

11. A computer program product for storing computer program code which, when run on a computer, performs the method of claim 1.

12. A computer system adapted to track one or more inputs at a touch sensitive surface, comprising:
a module for detecting one or more touch inputs in a first scanning frame;
a module for defining, for each detected touch input, a scanning window around a determined location of the detected touch input;
a module for scanning each defined scanning window, in a second scanning frame, to detect one or more touch inputs;
a module for associating a touch input detected in each scanning window in the second scanning frame with the touch input in the first scanning frame for which the scanning window was defined.

13. The computer system of claim 12 further comprising:
a module for scanning the surface in the first scanning frame to identify the one or more touch inputs.

14. The computer system of claim 12, further comprising:
a module for scanning the surface, in the second scanning frame, to detect one or more new touch inputs.

15. The computer system according to claim 14, further comprising:
a module for determining if a maximum number of touch inputs has been detected; and
a module for scanning the surface, in the second scanning frame, to detect one or more new touch inputs, only if the maximum number has not been reached.

16. The computer system according to claim 12 wherein the module for defining the scanning window around a determined location of the detected touch input further comprises:
a module for determining the number of contact points detected on the surface;
a module adapted for, in dependence on the number of contact points detected on the surface being greater than one:
determining the distance between a determined location of the detected touch input and a determined location of each further touch input;
sizing the scanning window for in dependence on the distance between the determined location of the detected touch input and a determined location of each further touch input being nearest thereto.

17. The method according to claim 16, wherein the module is further adapted such that if the distance between the determined location of the detected touch input and a determined location of each further touch input being nearest thereto is less than a threshold, the window is defined as a first size; and if the distance between the determined location of the detected touch input and a determined location of each further touch input being nearest thereto is greater than a threshold, the window is defined as a second size.

18. The computer system of claim 17 wherein the second size is greater than the first size.

19. The computer system of claim 17 wherein the module is further adapted such that if the number of contact points detected on the surface is one, the window is defined as the second size.

20. The computer system of claim 16 wherein the module is further adapted such that if the two touch inputs are considered as a single touch input if the distance between the determined location of the detected touch input and a determined location of the further touch input being nearest thereto is less than a further threshold.

21. (canceled)
